(19) United States
(12) Patent Application Publication
(10) Pub. No.: US 2022/0091614 A1
(43) Pub. Date: Mar. 24, 2022

(54) AUTONOMOUS DRIVING MODULE, MOBILE ROBOT INCLUDING THE SAME, AND POSITION ESTIMATION METHOD THEREOF

(71) Applicant: Polaris3D Co., Ltd, Gyeongsangbuk-do (KR)

(72) Inventors: Ho Yong LEE, Gyeongsangbuk-do (KR); In Veom KWAK, Gyeongsangbuk-do (KR); Chi Won SUNG, Gyeongsangbuk-do (KR)

(21) Appl. No.: 17/301,072

(22) Filed: Mar. 24, 2021

(30) Foreign Application Priority Data
Sep. 21, 2020 (KR) 10-2020-0121488

(51) Int. Cl. G05D 1/02; G01S 17/894; G01B 11/24; H04N 5/225; G06K 9/00; G06K 9/46; G06T 5/00; H04N 5/232

(52) U.S. Cl. CPC G05D 1/0251; G01S 17/894; G01B 11/24; H04N 5/232; G06K 9/00664; G06K 9/4661; G06T 5/005; H04N 5/2256

(57) ABSTRACT

An autonomous driving module included in a mobile robot includes a distance sensor configured to shoot a signal toward a floor every predetermined time and measure the time it takes for the signal to be reflected and returned to generate a plurality of pieces of height information. A light source is configured to emit light toward the floor, and a camera is configured to capture the floor every predetermined time to generate a plurality of floor images. The autonomous driving module includes a processor configured to execute instructions and a memory configured to store the instructions. The instructions are implemented to synchronize the plurality of pieces of height information with the plurality of floor images, and remove a region generated by reflection of the light source from the synchronized floor images.

### BACKGROUND

### 1. Field of the Invention

An embodiment according to the concept of the present invention relates to an autonomous driving module, a mobile robot including the same, and an operating method therefor, and more particularly, to an autonomous driving module that does not use an electromechanical encoder and instead performs the role of the electromechanical encoder using a camera, a mobile robot including the same, and a position estimating method thereof.

### 2. Discussion of Related Art

An encoder is an electromechanical device that converts the position or movement of a rotating shaft into an analog or digital signal. An encoder may be used to detect the position of a moving robot. The position of the moving robot may be estimated according to a signal obtained through the conversion by the encoder.

An encoder can be implemented in various ways, such as mechanical, magnetic, and optical methods. All of the above encoders are implemented using complicated and precise mechanical components. Mechanical components may have durability issues depending on their use. Also, when a shaft of a mobile robot does not rotate and the position of the mobile robot is changed due to sliding of the mobile robot, an encoder does not detect the movement of the shaft because the shaft of the mobile robot does not rotate. Therefore, when the position of the mobile robot is estimated by the encoder, the position of the mobile robot may be erroneously estimated.

A new method is needed to solve the issues of the electromechanical encoders.

### SUMMARY OF THE INVENTION

The technical object to be achieved by the present invention is an autonomous driving module that performs the role of a conventional electromechanical encoder using a camera instead of an electromechanical encoder in order to solve the problems of the conventional electromechanical encoder, and a mobile robot including the same, and a position estimating method thereof.

According to an aspect of the present invention, there is provided an autonomous driving module included in a mobile robot including a distance sensor configured to shoot a signal toward a floor every predetermined time and measure the time it takes for the signal to be reflected and returned to generate a plurality of pieces of height information, a light source configured to emit light toward the floor, and a camera configured to capture the floor every predetermined time to generate a plurality of floor images, the autonomous driving module including a processor configured to execute instructions and a memory configured to store the instructions. The instructions are implemented to synchronize the plurality of pieces of height information with the plurality of floor images, remove a region generated by reflection of the light source from the synchronized floor images, detect features from the plurality of floor images from which the region generated by the reflection of the light source is removed, and estimate a position of the mobile robot according to the detected features.

The instructions implemented to remove a region generated by reflection of the light source from the synchronized floor images are implemented to compute an average pixel value for each of the synchronized floor images, compute an outer diameter of a ring shape generated by the reflection of the light source for each of the synchronized floor images using information on an outer diameter of the light source, which is known in advance, and information on a height from the floor to the distance sensor, which is generated by the distance sensor, compute a center of the ring shape generated by the reflection of the light source using a distribution of pixel values for each of the synchronized floor images, compute a circle equation using the center of the ring shape and the outer diameter of the ring shape, compute an average pixel value in the ring shape using the circle equation, set a masking region for each of the synchronized floor images using the average pixel value and the average pixel value in the ring shape, and set the masking region as a region generated by the reflection of the light source.

According to an aspect of the present invention, there is provided a mobile robot including a light source configured to emit light toward a floor, a camera configured to capture the floor every predetermined time to generate a plurality of floor images, and an autonomous driving module.

The autonomous driving module includes a processor configured to execute instructions and a memory configured to store the instructions.

The instructions are implemented to synchronize the plurality of pieces of height information with the plurality of floor images, remove a region generated by reflection of the light source from the synchronized floor images, detect features from the plurality of floor images from which the region generated by the reflection of the light source is removed, and estimate a position of the mobile robot according to the detected features.

The mobile robot may further include a distance sensor installed on the mobile robot toward the floor and configured to shoot a signal toward the floor every predetermined time and measure the time it takes for the signal to be reflected and returned in order to generate the plurality of pieces of height information.

The instructions implemented to remove a region generated by reflection of the light source from the synchronized floor images are implemented to compute an average pixel value for each of the synchronized floor images, compute an outer diameter of a ring shape generated by the reflection of the light source for each of the synchronized floor images using information on an outer diameter of the light source, which is known in advance, and information on a height from the floor to the distance sensor, which is generated by the distance sensor, compute a center of the ring shape generated by the reflection of the light source using a distribution of pixel values for each of the synchronized floor images, compute a circle equation using the center of the ring shape and the outer diameter of the ring shape, compute an average pixel value in the ring shape using the circle equation, set a masking region for each of the synchronized floor images using the average pixel value and the average pixel value in the ring shape, and set the masking region as a region generated by the reflection of the light source.

According to an aspect of the present invention, there is provided a position estimation method of a mobile robot including a distance sensor configured to shoot a signal toward a floor every predetermined time and measure the time it takes for the signal to be reflected and returned to generate a plurality of pieces of height information, a light source configured to emit light toward the floor, and a camera configured to capture the floor every predetermined time to generate a plurality of floor images, the position estimation method including an operation in which a processor synchronizes the plurality of pieces of height information with the plurality of floor images, an operation in which the processor removes a region generated by reflection of the light source from the synchronized floor images, an operation in which the processor detects features from the plurality of floor images from which the region generated by the reflection of the light source is removed, and an operation of estimating a position of the mobile robot according to the detected features.

The operation in which the processor removes a region generated by reflection of the light source from the synchronized floor images includes an operation in which the processor computes an average pixel value for each of the synchronized floor images, an operation in which the processor computes an outer diameter of a ring shape generated by the reflection of the light source for each of the synchronized floor images using information on an outer diameter of the light source, which is known in advance, and information on a height from the floor to the distance sensor, which is generated by the distance sensor, an operation in which the processor computes a center of the ring shape generated by the reflection of the light source using a distribution of pixel values for each of the synchronized floor images, an operation in which the processor computes a circle equation using the center of the ring shape and the outer diameter of the ring shape, an operation in which the processor computes an average pixel value in the ring shape using the circle equation, an operation in which the processor sets a masking region for each of the synchronized floor images using the average pixel value and the average pixel value in the ring shape, and an operation in which the processor sets the masking region as a region generated by the reflection of the light source.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a mobile robot according to an embodiment of the present invention;

FIG. 2 is a bottom view of the mobile robot shown in FIG. 1;

FIG. 3 shows a floor image captured by a camera shown in FIG. 1 and floor images processed by a processor in order to describe the removal of a region caused by a light source shown in FIG. 1;

FIG. 4 shows a floor image captured by the camera shown in FIG. 1 to describe the removal of a region caused by the light source shown in FIG. 1;

FIG. 5 shows a portion of the image shown in FIG. 4 in order to describe the setting of a masking region in a region caused by the light source shown in FIG. 1;

FIG. 6 is a conceptual view illustrating the conversion of a pixel unit captured by the camera shown in FIG. 1 into a metric unit; and

FIG. 7 is a flowchart illustrating a method of estimating the position of the mobile robot shown in FIG. 1.

### DETAILED DESCRIPTION OF EXEMPLARY EMBODIMENTS

A specific structural or functional description of embodiments according to the inventive concept disclosed herein has merely been illustrated for the purpose of describing the embodiments according to the inventive concept, and the embodiments according to the inventive concept may be implemented in various forms and are not limited to the embodiments described herein.

Since the embodiments according to the inventive concept may be changed in various ways and may have various forms, the embodiments are illustrated in the drawings and described in detail herein. However, there is no intent to limit the embodiments according to the inventive concept to the particular forms disclosed. Conversely, the embodiments are to cover all modifications, equivalents, and alternatives falling within the scope of the invention.

In addition, the terms such as “first” or “second” may be used to describe various elements, but these elements are not limited by these terms. These terms are used to only distinguish one element from another element. For example, a first element could be termed a second element, and, similarly, a second element could be termed a first element without departing from the scope of the inventive concept.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, other expressions describing the relationships between elements should be interpreted in the same way (e.g., “between” versus “directly between,” “adjacent” versus “directly adjacent,” etc.).

The terms used herein are merely set forth to explain the embodiments of the present invention, and the scope of the present invention is not limited thereto. As used herein, the singular forms are intended to include the plural forms as well, unless the context clearly indicates otherwise. It should be further understood that the terms “comprises,” “comprising,” “includes,” “including,” “has” and/or “having,” when used in this specification, specify the presence of stated features, integers, steps, operations, elements, components, or groups thereof but do not preclude the presence or addition of one or more other features, integers, steps, operations, elements, components, or groups thereof.

Unless otherwise defined, all terms (including technical and scientific terms) used herein have the same meaning as commonly understood by those skilled in the art. Generally used terms, such as terms defined in dictionaries, should be construed as having meanings matching contextual meanings in the art. In this description, unless defined clearly, terms are not to be construed as having ideal or excessively formal meanings.

Hereinafter, the present invention will be described in detail by explaining exemplary embodiments of the present invention with reference to the accompanying drawings.

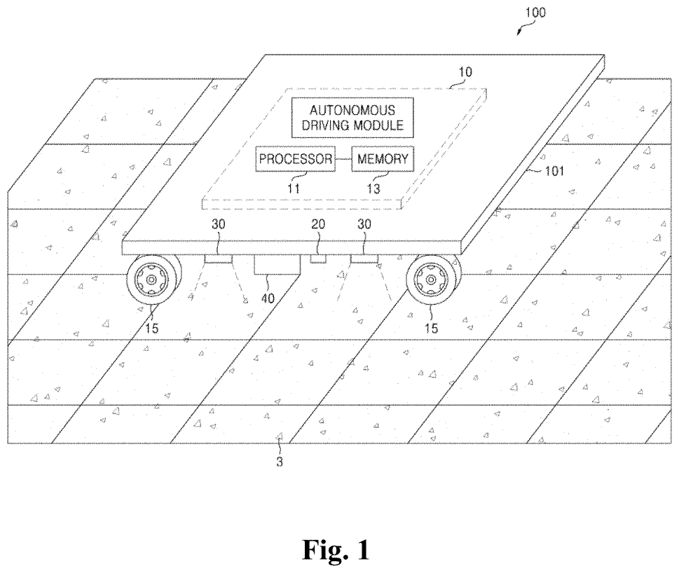

FIG. 1 is a block diagram of a mobile robot according to an embodiment of the present invention.

Referring to FIG. 1, a mobile robot 100 is used for the purpose of product transfer, product guidance, or inventory management in a mart, warehouse, factory, or shopping mall. In some embodiments, the mobile robot 100 may be used not only indoors but also outdoors.

The mobile robot 100 may be a device that is moved by a moving means such as a wheel 5. In some embodiments, the mobile robot 100 may be referred to with various terms such as an autonomous driving device, a transport robot, or an autonomous driving robot. The mobile robot 100 includes an autonomous driving module 10, a distance sensor 20, a light source 30, and a camera 40.

The autonomous driving module 10 is used to estimate the position of the mobile robot 100. The autonomous driving module 10 includes a processor 11 and a memory 13. The autonomous driving module 10 may be implemented inside the mobile robot 100 in the form of a board embedded with the processor 11 and the memory 13. Also, the autonomous driving module 10 may further include the distance sensor 20, the light source 30, or the camera 40 in addition to the processor 11 and the memory 13. That is, the distance sensor 20, the light source 30, or the camera 40 may be implemented in the autonomous driving module 10. The processor 11 executes instructions for estimating the position of the mobile robot 100. The instructions executed by the processor 11 to estimate the position of the mobile robot 100 will be described in detail below. The memory 13 stores the instructions. The instructions may be implemented as program code. The instructions may be referred to as an autonomous driving solution.

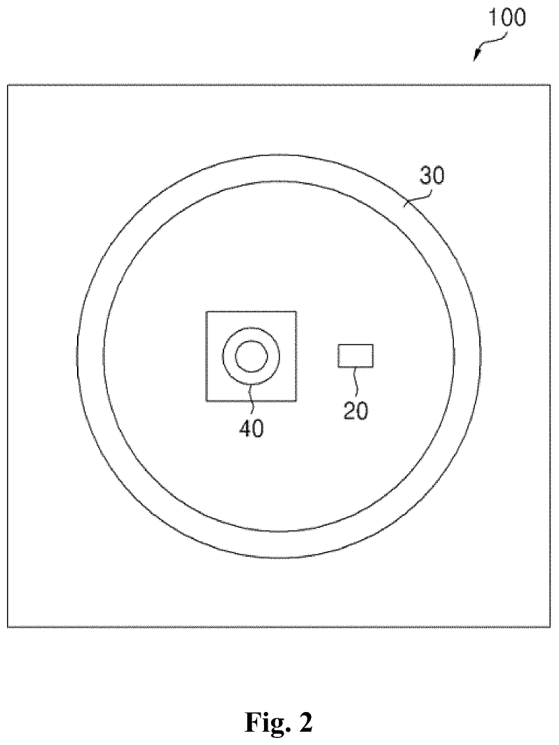

FIG. 2 is a bottom view of the mobile robot shown in FIG. 1. FIG. 2 shows a part of the bottom surface of the mobile robot and may be understood as the bottom surface of the autonomous driving module.

Referring to FIGS. 1 and 2, the distance sensor 20, the light source 30, and the camera 40 may be implemented on the bottom of a main body 101 of the mobile robot 100. That is, the distance sensor 20, the light source 30, and the camera 40 may be implemented toward a floor 3. Generally, the patterns of the floor 3 are not the same. The floor 3 has different patterns. By the camera 40 capturing the floor 3 with different patterns and analyzing floor images instead of a conventional electromechanical encoder, the position of the mobile robot 100 is estimated.

The distance sensor 20 is installed toward the floor 3 of the mobile robot 100. The distance sensor 20 generates a plurality of pieces of height information by shooting a signal toward the floor 3 every predetermined time and measuring the time it takes for the signal to be reflected and returned. The plurality of pieces of height information refer to information on the height from the floor 3 to the distance sensor 20. The distance sensor 20 may be implemented as various sensors such as a time-of-flight (ToF) sensor, an ultrasonic sensor, an infrared sensor, or a LiDAR sensor. The term “distance sensor” may be used herein, and the distance sensor 20 may be referred to with various terms such as a depth sensor, a three-dimensional (3D) depth sensor, a ToF camera, or a depth camera.

The camera 40 generates a plurality of floor images by capturing the floor 3 every predetermined time.

The light source 30 emits light toward the floor 3. The light source 30 is used to prevent degradation of the quality of the floor images caused by low light. Even if the surrounding illumination is bright, an image captured by the camera 40 is dark because the camera 40 is implemented on the bottom of the main body 101 of the mobile robot 100. The light source 30 is implemented in a ring shape so as not to affect the field of view of the distance sensor 20 and the camera 40.

The processor 11 receives the plurality of pieces of height information from the distance sensor 20 and the plurality of floor images from the camera 40.

The processor 11 synchronizes the plurality of pieces of height information with the plurality of floor images. The synchronization refers to matching height information and floor images generated at the same time. For example, the processor 11 matches first height information (e.g., H₁) and a first floor image (e.g., IMG1), which are generated at a first time (e.g., T₁), to confirm that the first height information H1 and the first floor image IMG1 are generated at the first time T₁. The plurality of pieces of height information represent information generated by the distance sensor 20, and the plurality of floor images represent information generated by the camera 40. That is, the pieces of information are generated by different devices 20 and 40, and thus a process of matching the pieces of information is necessary.

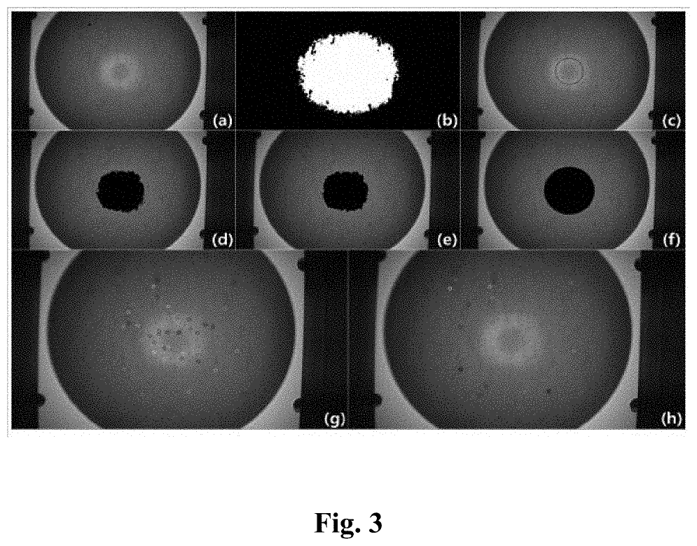

FIG. 3 shows a floor image captured by a camera shown in FIG. 1 and floor images processed by a processor in order to describe removal of a region caused by a light source shown in FIG. 1.

Referring to FIGS. 1 to 3, when the annular light source 30 emits light toward the floor, the light is reflected from the floor. When the camera 40 captures the floor to generate a floor image, a region generated by the reflection of the light source 30 is included in the floor image. In FIG. 3A, a ring shape indicates a region generated by the reflection of the light source 30.

When the region generated by the reflection of the light source 30 is not removed from the floor image, an error occurs while the processor 11 extracts feature points to estimate the position of the mobile robot 100. This is because the processor 11 will extract the region generated by the reflection of the light source 30 as the feature points and the feature points may be confused with the feature points of the floor 3. Referring to FIG. 3G, it can be seen that the feature points on the periphery of the region generated by the reflection of the light source 30 are extracted rather than the feature points of the floor 3.

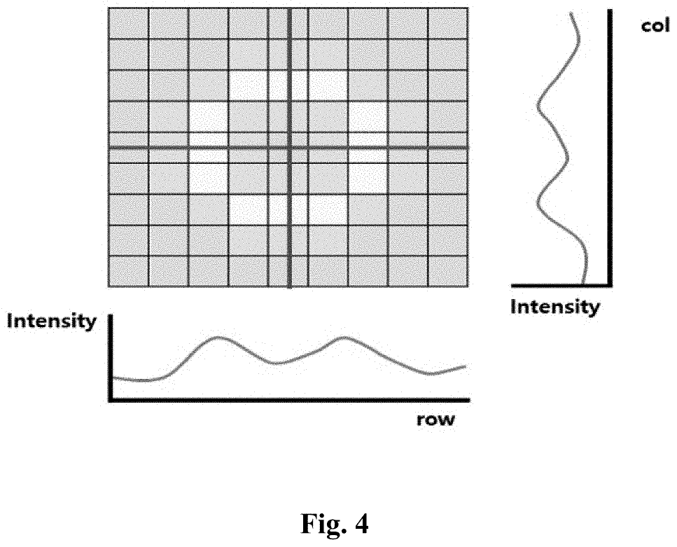

FIG. 4 shows a floor image captured by the camera shown in FIG. 1 to describe removal of a region caused by the light source shown in FIG. 1.

Referring to FIGS. 1, 2, and 4, operations for removing a region generated by the reflection of the light source 30 from a floor image will be described.

The processor 11 computes an overall average pixel value for the floor image.

$$API = \frac{1}{n} {\sum }_{k = 1}^{n} I ( k ) \qquad [ Equation 1 ]$$

Here, API is an overall average pixel value for the floor image, n is the total number of pixels of the floor image, and I(k) is a k^{th} pixel value.

The processor 11 computes the outer diameter of the ring shape in the floor image using information on the outer diameter of the light source 30, which is known in advance through the specification (spec), and information on the height from the floor 3 to the distance sensor 20, which is generated by the distance sensor 20. The outer diameter of the ring shape in the floor image may be computed through Equations 2 and 3. The specification refers to a specification for the light source 30.

The region generated by the reflection of the light source 30 has a ring shape similar to a circle. Therefore, the processor 11 may compute the diameter of an outer circle, that is, an outer diameter in the bottom image, assuming that the ring shape is a circle. The actual position of the light source 30 in the mobile robot 100 may be different from the specification due to a production error.

D_{normalizedringLED}=D_{ringLED}/TOF [Equation 2]

Here, D_{normalizedringLED} represents a normalized coordinate for the outer diameter of the light source 30, D_{ringLED} represents the actual outer diameter of the light source 30 known in advance through the specification, and TOF represents information regarding the height from the floor 3 to the distance sensor 20 generated by the distance sensor 20. D_{ringLED} is expressed in world coordinates. D_{normalizedringLED}, which is a normalized coordinate for the outer diameter of the light source 30, may be computed using Equation 2 above.

D_{c}=K*D_{normalizedringLED} [Equation 3]

D_{c} represents the outer diameter of the ring shape in the floor image, and K represents a camera-intrinsic parameter such as a focal length and a lens distortion of the camera. D_{c} represents an image coordinate. D_{c}, which is the outer diameter of the ring shape in the floor image, may be computed using Equation 3 above.

In FIG. 4, the graph on the right represents pixel values according to columns of the floor image, and the graph on the lower side represents pixel values according to rows of the floor image.

Referring to the graph of FIG. 4, the center of the ring shape, which is the region generated by the reflection has the minimum pixel value. Regions to the left and right from the center of the ring shape have the maximum pixel value. The minimum pixel value and the maximum pixel value correspond to inflection points of the curve shown in the graph. That is, the curve shown in FIG. 4 is similar to the curve of a quadratic equation. Therefore, the position of the pixel at which the distance between the inflection points of the curve of the quadratic equation is the maximum is the center of the ring shape, which is the region generated by the reflection. The processor 11 estimates the quadratic equation from the curve of the graph of FIG. 4 using polynomial function fitting. The quadratic equation may be expressed using Equation 4 below.

y(x)=a₀x⁴+a₁x³+a₂x²+a₃x+a₄ [Equation 4]

Here, y(x) represents a pixel value, and x represents a row or column of an image shown in FIG. 4. In the case of the graph on the lower side of the image shown in FIG. 4, x denotes a row of the image shown in FIG. 4. In the case of the graph on the left of the image shown in FIG. 4, x denotes a column of the image shown in FIG. 4. a₀, a₁, a₂, a₃, and a₄ denote coefficients.

Equation 4 may be expressed as Equation 4 below. That is, the processor 11 may transform Equation 4 into Equation 5.

$$[ \begin{matrix}y ( {x}_{1} ) \\ y ( {x}_{2} ) \\ … \\ y ( {x}_{n} )\end{matrix} ] = [ \begin{matrix}1 & {x}_{1} & {x}_{1}^{2} & {x}_{1}^{3} & {x}_{1}^{4} \\ 1 & {x}_{2} & {x}_{2}^{2} & {x}_{2}^{3} & {x}_{2}^{4} \\ … & … & … & … & … \\ 1 & {x}_{n} & {x}_{n}^{2} & {x}_{n}^{3} & {x}_{n}^{4}\end{matrix} ] [ \begin{matrix}a 0 \\ a 1 \\ a 2 \\ a 3 \\ a 4\end{matrix} ] \qquad [ Equation 5 ]$$

Also, Equation 5 may be transformed into Equation 6 below. That is, the processor 11 may transform Equation 5 into Equation 6.

Y=XA [Equation 6]

Here, A represents a matrix of a₀, a₁, a₂, a₃, and a₄. Y and X represent matrices corresponding to y(x) and x in Equation 5.

Equation 6 may be transformed into Equation 7. That is, the processor 11 may transform Equation 6 into Equation 7.

A=X(X^{T}X)⁻¹X^{T}y [Equation 7]

The processor 11 may use Equation 7 to compute the matrix A, which is the matrix of a₀, a₁, a₂, a₃, and a₄. That is, the processor 11 may compute a₀, a₁, a₂, a₃, and a₄, which are coefficients of the quadratic equation. The processor 11 may compute the distance between inflection points in the computed quadratic equation. The distance between the inflection points may be expressed using Equation 8.

d=|MILeft−MIRight| [Equation 8]

Here, d represents the distance between inflection points, and MILeft and MIRight are a left inflection point and a right inflection point in the graph shown in FIG. 4.

The processor 11 computes the center of the ring shape using the distance between pixel values of the floor image. The center of the ring shape is expressed using Equation 9.

R_{cx}=max∥MILeft−MIRIGHT∥(I_{row})

R_{cy}=max∥MILeft−MIRIGHT∥(I_{column}) [Equation 9]

Here, Rcx represents an x-coordinate of the center of the ring shape of the image shown in FIG. 4, and Rcy represents a y-coordinate of the ring shape of the image shown in FIG. 4. Here, Irow represents a curve corresponding to the graph on the lower side and Icolumn is a curve corresponding to the graph on the right. MILeft and MIRight represent pixel values, and max represents an operator that selects the maximum value.

The processor 11 represents the ring shape as a circle equation. The circle equation is equal to Equation 10 below. FIG. 3C shows a circle corresponding to the circle equation computed by the processor 11.

(x−R_{cx})²+(y−R_{cy})²=D_{c}² [Equation 10]

Also, the processor 11 transforms Equation 10 into Equation 11. Equation 11 is as follows. FIG. 3F shows an image in which the circle corresponding to the circle equation computed by the processor 11 is set as a mask.

(x−R_{cx})²+(y−R_{cy})²=D_{c}²=K [Equation 11]

Here, K represents an arbitrary constant, which is different from K disclosed in Equation 3.

D_{c} represents the outer diameter of the ring shape in the floor image.

$${I}_{r} ( x , y ) = \{ \begin{matrix}Unchanged , & if K \leq 2 \\ 0 , & otherwise\end{matrix} \qquad [ Equation 12 ]$$

Here, Ir(x,y) is a pixel value in the ring shape, and K represents a tolerance. The value of K is expressed as 2, which is the size of two pixels, but the pixel of K may vary depending on the embodiment.

When the position (x,y) of the pixel is located inside the ring shape, the value of the pixel is maintained. However, when the position (x,y) of the pixel exceeds the tolerance (K) and is located outside the ring shape, the value of the pixel is set to zero.

The processor 11 may compute an average pixel value of the ring shape by adding up pixel values Ir(x,y) in the ring shape and dividing the sum by the total number. The average pixel value of the ring shape may be computed using Equation 13 below.

$$RRAPI = \frac{1}{m} {\sum }_{p = 1}^{m} {I}_{r} ( p ) \qquad [ Equation 13 ]$$

Here, RRAPI represents an average pixel value in the ring shape, m represents the total number of pixels in the ring shape, and Ir(p) represents a p^{th} pixel value in the ring shape.

The processor 11 may use Equation 1 and Equation 13 to compute a threshold THRES as Equation 14 below.

$$THRES = \frac{API + RRAPI}{2} \qquad [ Equation 14 ]$$

The processor 11 sets, as a masking region, pixels having pixel values greater than the threshold THRES computed in the floor image. FIG. 3D shows a mask image set by the threshold (THRES).

In some embodiments, the processor 11 checks whether a pixel that is set as a masking region is on the periphery each of the pixels that are set in the masking region.

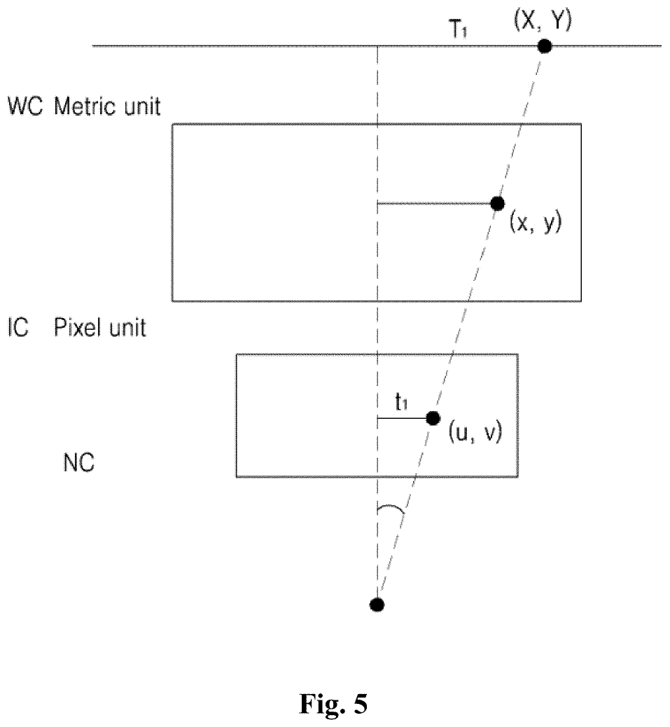

FIG. 5 shows a portion of the image shown in FIG. 4 in order to describe the setting of a masking region in a region caused by the light source shown in FIG. 1. In FIG. 5, a black pixel represents a pixel that is set as the masking region, and a white pixel represents a pixel that is not set as the masking region.

Referring to FIGS. 1, 4, and 5, when no pixel that is set as the masking region is on the periphery of each of the pixels that are set as the masking region (for example, P1 to P9, and P21), the processor 11 excludes the corresponding pixel that has been set as the masking region from the masking region. For example, since pixels (e.g., P22 to P28) which are set as the masking region are not on the periphery of a pixel P21, the processor 11 excludes the pixel P21 which is set as the masking region from the masking region. The periphery is defined as eight neighboring pixels adjacent to each pixel. For example, the periphery of the pixel P1 includes eight neighboring pixels P2 to P9 adjacent to the pixel P1.

On the contrary, when a pixel that is set as a masking region is on the periphery of each of the pixels that are set as the masking region, the pixel that is set as the masking region is maintained in the masking region. For example, since the pixels P2, P4, and P7, which are set as the masking region, are on the periphery of the pixel P1, the processor 11 maintains the pixel P1, which is set as the masking region, in the masking region. FIG. 3E represents a mask image that is set in consideration of neighboring pixels.

The processor 11 detects features from the plurality of floor images except for the region that is set as the masking region. The processor 11 removes the region generated by the reflection of the light source 30 in order to detect features from the plurality of floor images. The masking region is a region generated by the reflection of the light source 30.

The processor 11 detects features from the plurality of floor images from which the region generated by the reflection of the light source 30 is removed. Well-known algorithms such as Features from Accelerated Segment Test (FAST), Speeded-Up Robust Feature (SURF), or Scale Invariant Feature Transform (SIFT) may be used to detect the features from the plurality of floor images. FIG. 3H represents features detected from the plurality of floor images from which the region generated by the reflection of the light source 30 is removed. That is, FIG. 3H shows the features detected from the images except for the masking region.

The processor 11 extracts the detected features. Feature descriptors or feature vectors are derived by the extraction.

The processor 11 matches features detected in floor images generated at different times using the detected features and feature descriptors.

The processor 11 computes a transformation matrix according to the matching result. The relationship between the features detected in the floor images generated at different times is derived through the transformation matrix. The features detected in the floor images generated at different times are rotated or translated. Therefore, the transformation matrix may be implemented as a rotation matrix, a translation matrix, or a combination thereof.

The transformation matrix is a pixel unit, which is an image coordinate. The pixel unit, which is an image coordinate, should be changed to a metric unit, which is a world coordinate.

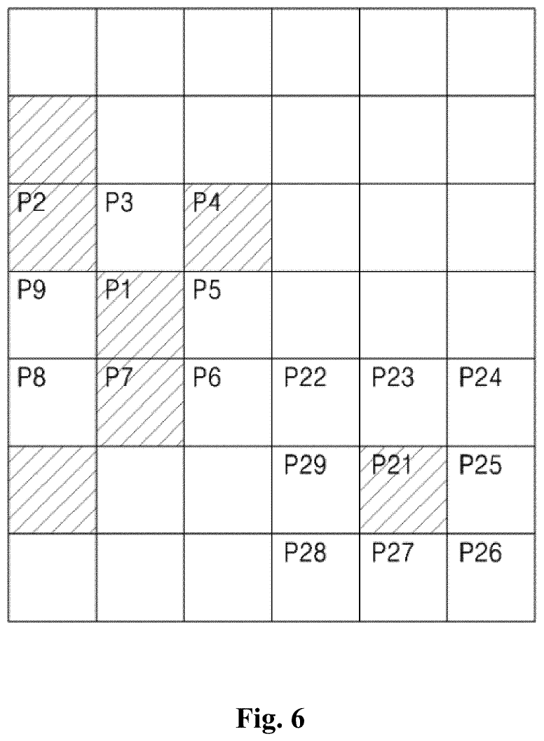

FIG. 6 is a conceptual view illustrating the conversion of a pixel unit captured by the camera shown in FIG. 1 into a metric unit.

The processor 11 first converts a pixel unit, which is an image coordinate (IC), into a unit vector, which is a normal coordinate (NC). The pixel unit, which is the image coordinate (IC), is a coordinate according to a focal length indicating the distance between a lens and an image sensor. The unit vector, which is the normal coordinate (NC), is a coordinate when the focal length is one. Therefore, the processor 11 converts a pixel unit, which is an image coordinate (IC), into a unit vector, which is a normal coordinate (NC), using the focal distance of the camera 40.

The processor 11 transforms the normal coordinate (NC) into the world coordinate (WC). The transformation of the normal coordinate (NC) into the world coordinate (WC) is performed in the following order.

The processor 11 computes Equation 15.

$$ρ = \frac{1}{n} {\sum }_{i = 1}^{n} \frac{{T}_{i}}{{t}_{i}} \qquad [ Equation 15 ]$$

Here, p represents a scale parameter indicating the ratio of the world coordinate (WC) to the normal coordinate (NC), t, represents how far the normal coordinate (NC) is from a virtual x-axis with respect to a virtual y-axis, and Tᵢ represents how far the world coordinate (WC) is from a virtual x-axis with respect to a virtual y-axis.

The processor 11 computes Equation 16.

[Equation 16]

Here, ToF represents the height from the distance sensor 20 to the floor, ti represents how far the normal coordinate (NC) is from the virtual x-axis with respect to the virtual y-axis, and Ti represents how far the world coordinate (WC) is from the virtual x-axis with respect to the virtual y-axis.

The processor 11 may use Equation 16 to compute Equation 15 as Equation 17 below.

$$ρ = \frac{1}{n} {\sum }_{i = 1}^{n} \frac{‖ {t}_{i} ‖ * ToF}{‖ {t}_{i} ‖} \qquad [ Equation 17 ]$$

The processor 11 may compute Equation 17 as Equation 18 below.

$$ρ = \frac{1}{n} * n \frac{‖ {t}_{i} ‖ * ToF}{‖ {t}_{i} ‖} \qquad [ Equation 18 ]$$

The processor 11 may compute Equation 18 as Equation 19 below.

[Equation 19] 01′

That is, the processor 11 may transform the normal coordinate (NC) into the world coordinate (WC) by multiplying the normal coordinate (NC) by the height from the distance sensor 20 to the floor (ToF).

In summary, the processor 11 may transform an image coordinate (IC) into a normal coordinate (NC) by dividing the transformation matrix expressed as the image coordinate (IC) by the focal distance of the camera 40 and may transform the normal coordinate (NC) into a world coordinate (WC) by multiplying the normal coordinate (NC) by the height from the distance sensor 20 to the floor (ToF).

The processor 11 estimates the position of the mobile robot 100 according to the extracted feature points. Specifically, the processor 11 estimates the position of the mobile robot 100 by accumulating transformation matrices computed from a plurality of floor images generated at different times.

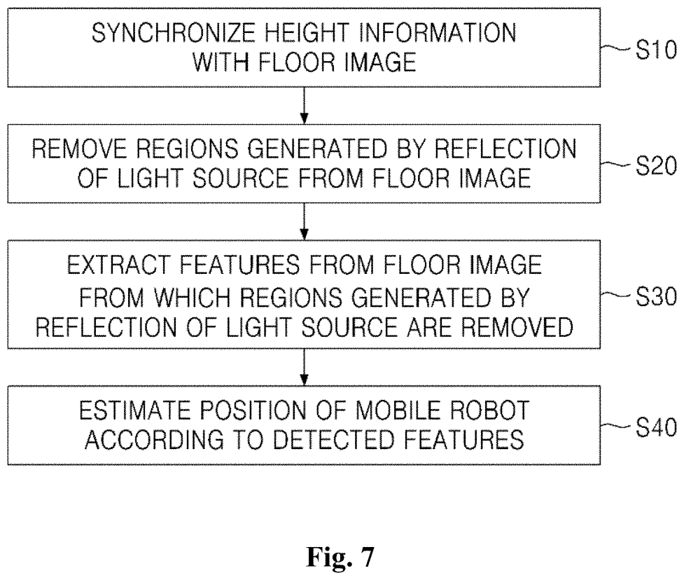

FIG. 7 is a flowchart illustrating a method of estimating the position of the mobile robot shown in FIG. 1.

Referring to FIGS. 1 and 7, a processor 11 synchronizes a plurality of pieces of height information with a plurality of floor images (S10).

The processor 11 removes a region generated by the reflection of a light source 30 from the synchronized floor images (S20). Specific operations of removing the region generated by the reflection of the light source 30 from the synchronized floor images are as follows.

The processor 11 computes an average pixel value for each of the synchronized floor images. The processor 11 computes the outer diameter of a ring shape generated by the reflection of the light source 30 for each of the synchronized floor images by using information on the outer diameter of the light source 30, which is known in advance, and information on the height from the floor to the distance sensor 20 which is generated by the distance sensor 20. The processor 11 computes the center of the ring shape generated by the reflection of the light source 30 using the distribution of pixel values for each of the synchronized floor images. The processor 11 computes a circle equation using the center of the ring shape and the outer diameter of the ring shape. The processor 11 computes an average pixel value in the ring shape using the circle equation. The processor 11 sets the masking region for each of the synchronized floor images using the average pixel value and the average pixel value in the ring shape. The processor 11 sets the masking region as the region generated by the reflection of the light source 30.

The processor 11 detects features from the plurality of floor images from which the region generated by the reflection of the light source 30 is removed (S30).

The processor 11 estimates the position of the mobile robot 100 according to the detected features (S40).

The autonomous driving module, the mobile robot including the same, and the position estimation method thereof according to embodiments of the present invention can overcome the disadvantages of the conventional electromechanical encoder by estimating the position of the mobile robot using a camera instead of the electromechanical encoder.

While the present invention has been described with reference to an embodiment shown in the accompanying drawings, it should be understood by those skilled in the art that this embodiment is merely illustrative of the invention and that various modifications and equivalents may be made without departing from the spirit and scope of the invention. Accordingly, the technical scope of the present invention should be determined only by the technical spirit of the appended claims.

What is claimed is:

1. An autonomous driving module included in a mobile robot including a distance sensor configured to shoot a signal toward a floor every predetermined time and measure the time it takes for the signal to be reflected and returned to generate a plurality of pieces of height information, a light source configured to emit light toward the floor, and a camera configured to capture the floor every predetermined time to generate a plurality of floor images, the autonomous driving module comprising:
a processor configured to execute instructions; and
a memory configured to store the instructions,
wherein the instructions are implemented to synchronize the plurality of pieces of height information with the plurality of floor images, remove a region generated by reflection of the light source from the synchronized floor images, detect features from the plurality of floor images from which the region generated by the reflection of the light source is removed, and estimate a position of the mobile robot according to the detected features.

2. The autonomous driving module of claim 1, wherein the instructions implemented to remove a region generated by reflection of the light source from the synchronized floor images are implemented to compute an average pixel value for each of the synchronized floor images, compute an outer diameter of a ring shape generated by the reflection of the light source for each of the synchronized floor images using information on an outer diameter of the light source, which is known in advance, and information on a height from the floor to the distance sensor, which is generated by the distance sensor, compute a center of the ring shape generated by the reflection of the light source using a distribution of pixel values for each of the synchronized floor images, compute a circle equation using the center of the ring shape and the outer diameter of the ring shape, compute an average pixel value in the ring shape using the circle equation, set a masking region for each of the synchronized floor images using the average pixel value and the average pixel value in the ring shape, and set the masking region as a region generated by the reflection of the light source.

3. A mobile robot comprising:
a light source configured to emit light toward a floor;
a camera configured to capture the floor every predetermined time to generate a plurality of floor images; and
an autonomous driving module,
wherein the autonomous driving module comprises:
a processor configured to execute instructions; and
a memory configured to store the instructions,
wherein the instructions are implemented to synchronize a plurality of pieces of height information with the plurality of floor images, remove a region generated by reflection of the light source from the synchronized floor images, detect features from the plurality of floor images from which the region generated by the reflection of the light source is removed, and estimate a position of the mobile robot according to the detected features.

4. The mobile robot of claim 3, further comprising a distance sensor installed on the mobile robot toward the floor and configured to shoot a signal toward the floor every predetermined time and measure the time it takes for the signal to be reflected and returned in order to generate the plurality of pieces of height information.

5. The mobile robot of claim 2, wherein the instructions implemented to remove a region generated by reflection of the light source from the synchronized floor images are implemented to compute an average pixel value for each of the synchronized floor images, compute an outer diameter of a ring shape generated by the reflection of the light source for each of the synchronized floor images using information on an outer diameter of the light source, which is known in advance, and information on a height from the floor to the distance sensor, which is generated by the distance sensor, compute a center of the ring shape generated by the reflection of the light source using a distribution of pixel values for each of the synchronized floor images, compute a circle equation using the center of the ring shape and the outer diameter of the ring shape, compute an average pixel value in the ring shape using the circle equation, set a masking region for each of the synchronized floor images using the average pixel value and the average pixel value in the ring shape, and set the masking region as a region generated by the reflection of the light source.

6. A position estimation method of a mobile robot including a distance sensor configured to shoot a signal toward a floor every predetermined time and measure the time it takes for the signal to be reflected and returned to generate a plurality of pieces of height information, a light source configured to emit light toward the floor, and a camera configured to capture the floor every predetermined time to generate a plurality of floor images, the position estimation method comprising:
an operation in which a processor synchronizes the plurality of pieces of height information with the plurality of floor images;
an operation in which the processor removes a region generated by reflection of the light source from the synchronized floor images;
an operation in which the processor detects features from the plurality of floor images from which the region generated by the reflection of the light source is removed; and
an operation in which the processor estimates a position of the mobile robot according to the detected features.

7. The position estimation method of claim 6, wherein the operation in which the processor removes a region generated by reflection of the light source from the synchronized floor images comprises:
an operation in which the processor computes an average pixel value for each of the synchronized floor images;
an operation in which the processor computes an outer diameter of a ring shape generated by the reflection of the light source for each of the synchronized floor images using information on an outer diameter of the light source, which is known in advance, and information on a height from the floor to the distance sensor, which is generated by the distance sensor;
an operation in which the processor computes a center of the ring shape generated by the reflection of the light source using a distribution of pixel values for each of the synchronized floor images;
an operation in which the processor computes a circle equation using the center of the ring shape and the outer diameter of the ring shape;
an operation in which the processor computes an average pixel value in the ring shape using the circle equation;
an operation in which the processor sets a masking region for each of the synchronized floor images using the average pixel value and the average pixel value in the ring shape; and
an operation in which the processor sets the masking region as a region generated by the reflection of the light source.
